(19) United States
(12) Patent Application Publication
(10) Pub. No.: US 2009/0065075 A1
(43) Pub. Date: Mar. 12, 2009

(54) PRESSURE CONTROL VALVE

(75) Inventors: Thilo Schmidt, Meckenbeuren (DE); Markus Moosmann, Ravensburg (DE); Karlheinz Mayr, Bregenz (AT)

Correspondence Address: DAVIS & BUJOLD, P.L.L.C., 112 PLEASANT STREET, CONCORD, NH, 03301, US

(73) Assignee: ZF Friedrichshafen AG, Friedrichshafen (DE)

(21) Appl. No.: 12/197,484

(22) Filed: Aug. 25, 2008

(30) Foreign Application Priority Data
Sep. 8, 2007 (DE) 10 2007 042 891.1

(51) Int. Cl. F15B 13/044; F16K 31/06

(52) U.S. Cl. 137/596.17; 251/129.15

(57) ABSTRACT

A pressure control valve (1) designed as a closed-end pressure regulator is proposed, which comprises two valve seats (7, 11) arranged in a hydraulic half-bridge circuit, with an electromagnet (2) having a magnetic core, a magnetic coil (3), and a displaceable armature (4), with an anchor rod (5) displaceable by the armature (4) for a closing part (6), which can be made to strike against a first valve seat (7) of the tank edge, and with a push rod (9), which is connected to the anchor rod (5) or is designed as a single piece with the anchor rod (5), which can move a locking element (10) designed as a ball out of a ball seat (11) of the inlet control edge, in which the push rod (9) is configured in such a way at its end facing the ball seat (11) that the opening cross-section of the inlet control edge (12), that is, the ball seat (11), can be modified depending on the axial position of the push rod (9) in such a way that the cross-section is reduced when the target pressure is low, in order to reduce the inlet volume flow, while the total cross-section of the inlet edge (12) is made available when the target pressure is high and/or in which the valve seat (11) is designed in such a way that its diameter on the side facing the ball (10) is smaller than the diameter on the side facing away from the ball (10).

This application claims priority from German Application Serial No. 10 2007 042 891.1 filed Sep. 8, 2007.

### FIELD OF THE INVENTION

The invention concerns a pressure control valve.

### BACKGROUND OF THE INVENTION

It is generally known from the prior art to utilize wet-running disk shifting elements for torque transmission in automatic transmissions of motor vehicles.

Here torque transmission is effected in a friction-driven manner by pressing on the disk sets of the shifting elements, wherein for this purpose the required contact pressure on the disk set is generated via a hydraulically operated clutch piston, which is actuated via a pressure control valve (clutch valve). The pressure control valves of the shifting elements are either directly actuated or controlled via pressure limiting valves or precontrol valves connected upstream.

A magnetic force, which is proportional to the control current and by way of which the purely hydraulic pressure control valves of the shifting element are shifted, is generated in both cases. The working pressure of the clutch valves is produced by the equilibrium condition of the force that is proportional to the control current (=actuating force) and the return force (=reaction force) of the pressure control valve.

A closed-end pressure regulator (CE-DR), which features two valve seats arranged in hydraulic half-bridge circuit, wherein a ball seat geometry is used at the inlet side and a flat or ball seat geometry is used on the tank side, is frequently used, according to the prior art, for control in the case in which the pressure control valve is controlled via a pressure regulator connected upstream or via a pressure limiting valve (precontrol valve) connected upstream.

In an advantageous manner, a closed-end pressure regulator allows minimization of leakage oil flow in the end positions. The desired minimal pressure, the inlet control edge is closed and the leakage oil flow from the inlet control edge to the tank edge is thus reduced to almost 0 ml/min. This is necessary, because one actuator should ideally be directly associated with each shifting element of an automatic transmission in order to be able to represent each possible shift change.

Without the closed-end function, each precontrol valve would have a maximum leakage between the inlet edge and the tank edge at a minimal pressure requirement. With a large quantity of shifting elements to be controlled, the result would thus be a very high oil volume requirement in the hydraulic system of the vehicle's hydraulic pump.

A precontrol valve such as this is known from DE 103 42 892 A1 of the Applicant. A proportional pressure limiting valve with a magnetic part and a valve part is described within the scope of DE 103 42 892 A1, wherein the valve part is provided with an inlet opening for the inlet volume flow, a first outlet opening for the filling volume flow and a second outlet opening for the tank volume flow and a ball seat, a flat seat provided with an opening, a closing part for controlling the flow rate through the opening of the flat seat, and a stream diverter arranged between the ball seat and the flat seat.

WO 98/48332 of the Applicant also discloses a pressure control valve configured as closed-end pressure regulator, having a connection for a pressure line, a connection for a working pressure line and a connection for an outlet line to the ambient pressure and at least two aperture stages with defined and definable flow resistance of which two aperture stages are variably coupled under mechanical or hydraulic action according to the principle of the hydraulic half bridge. Both variable aperture stages are provided as inlet and outlet apertures of a control pressure chamber and feature a sealing element, wherein the sealing element of the inlet aperture is configured as a ball or calotte or truncated cone or cylinder and/or the sealing element of the outlet aperture is configured as a ball or calotte or truncated cone or cylinder.

The known pressure control valves configured as a closed-end pressure regulator must make possible a high dynamic at the follow-up slide valve on the one hand, while the leakage must be as low as possible on the other hand.

The transition from the inlet seat to the tank seat is carried out very abruptly, so that the leakage volume flow of the pressure regulator increases abruptly without achieving a substantial pressure increase. This is necessary in order to keep the disturbing influences in the reducing pressure away from the working pressure to the extent possible, but leads to the disadvantage that a high leakage oil volume is produced in the low pressure range of the pressure regulator, while a high volume flow requirement of the transmission is present at the same time in this pressure range, for example, for the purpose of filling the clutch.

The geometric configuration of the ball seat actuated by means of a push rod essentially determines the maximum leakage or the maximum volume flow of the pressure regulator, while the cross-section of the inflow edge is reduced according to the prior art by way of the push rod, which features a cylindrical geometry that remains essentially the same when viewed from the axial direction.

When a high pressure and volume flow requirement occur, the push rod of the pressure regulator is displaced to completely close the tank edge, wherein the maximum volume flow is required in this situation in order to bring the follow-up slide valve into its control position. When the control position is reached, there is very little or no volume flow requirement at the pressure regulator with reference to the working pressure, so that the inlet volume flow at the inlet control edge can be reduced.

It is therefore the object of the invention to disclose a pressure control valve configured as a closed-end pressure regulator, in which the cross-section is reduced when the target pressure is low in order to reduce the inlet volume flow, and the total cross-section of the inlet edge is available when the target pressure is high in order to satisfy the high volume flow requirements of the follow-up slide valve on the one hand, and to be able to compensate for a high leakage in the working pressure on the other.

### SUMMARY OF THE INVENTION

According to an advantageous further development of the invention, the push rod is consequently configured in such a way at its end that faces the ball seat that the opening cross-section of the inlet edge can be modified depending on the axial position of the push rod, in such a way that when the target pressure is low, the cross-section is reduced in order to reduce the inlet volume flow, while when the target pressure is high, the total cross-section of the inlet edge is available in order to satisfy the high volume flow requirements of the follow-up slide valve on the one hand, and to be able to compensate for a high leakage in the working pressure on the other hand.

Preferably the push rod features a geometric expansion in the area of its end that faces the ball seat, which results in a position-dependent cross-sectional constriction, wherein the pressure/flow/flowthrough behavior of the pressure regulator is determined by the axial position and contour of the geometric expansion. The geometric expansion can hereby have the shape of a truncated cone that tapers in the direction of the ball seat, or can have a cylindrical, concave or convex shape. A double cone shape is likewise possible. The geometric expansion is not utilized to close the inlet control edge; the available geometry of the sealing element, which is configured as a cone, remains unchanged.

The transition of the inlet control edge to the tank control edge, which is carried out abruptly without the geometric expansion, can be made more gentle by way of this configuration of the push rod, whereby a startup jump in the pressure control characteristic is prevented. Further, when the volume flow requirement is low, a laminar flow can be converted into a turbulent flow in this way, which facilitates the passage of the oil at low temperatures.

As an alternative or in addition to the configuration of the push rod according to the invention, the ball seat can be designed according to the invention in such a way that its diameter on the side facing the ball is smaller than its diameter on the side facing away from the ball. The sharpened shape of the ball seat causes the conversion of a laminar flow into a turbulent flow, which facilitates the passage of the oil at low temperatures.

The problem with the current design of the pressure control valves configured as closed-end pressure regulators is that the inlet volume flow is highly reduced at low oil temperatures due to the viscous behavior of the oil, which leads to a disadvantageous reduction of the valve dynamic, in particular that of the precontrolled clutch valves. Compensating for this effect by way of a larger inlet geometry proves to be disadvantageous, since the leakage volume flow is greatly increased at high temperatures.

According to a further aspect of the invention, a pressure control valve configured as a closed-end pressure regulator is proposed, in which the cross-section of the inlet control edge (that is, the valve or ball seat) can be modified depending on the temperature, in such a way that the cross-section is opened as widely as possible at low oil temperatures in order to make a large volume flow to the follow-up slide valves possible, while at high oil temperatures the cross-section of the inlet control edge is reduced to the extent that a high valve dynamic of the follow-up slide valve is achieved on the one hand, and the leakage oil flow is not significantly increased on the other.

It is proposed within the scope of a particularly advantageous embodiment of the invention that the ball seat be made from a material whose heat expansion coefficient is considerably greater than the heat expansion coefficient of the push rod, so that at higher temperatures it features a disproportionately greater geometric expansion in comparison with the material of the push rod. This ensures that the cross-section of the inlet control edge has an ever smaller cross-section surface at increasing temperature.

The cross-section reduction in a circular cross-section is proportional to the square of the temperature, since the diameter of the cross-section is linearly reduced with the temperature and the surface of the cross-section and thus the flow through the cross-section is therefore related to the square of the cross-section diameter.

According to a particularly advantageous further development of the invention, the ball seat is formed by an annular disk, wherein a stable supporting ring that is mounted in a fixed manner in a housing is provided on the outer diameter of the disk, by way of which the thermal expansion of the annular disk is guided inward as viewed from the radial direction.

The supporting ring is preferably made of a material that has approximately the same heat expansion coefficient as that of the material of the push rod, whereby the cross-section of the inlet control edge can be determined in an advantageous way by selection of the material for the annular disk that forms the ball seat.

According to the invention, the annular disk that forms the ball seat can be composed of a plastic material which features nonlinear heat expansion behavior above the glass transition point. In this way a disproportionate reduction of the cross-section of the inlet control edge above the glass transition point of the plastic can be achieved, for example, by utilizing a polyphenylene sulfide (PPS plastic); a typical value is around 80° C.

As an alternative to a material having a large heat expansion coefficient for the ball seat, according to another embodiment of the invention, a material having a negative heat expansion coefficient, such as a GFK material (fiberglass-reinforced plastic), for example, can be used for the ball seat. The cross-section of the inlet control edge is reduced when the temperature increases by way of an annular disk of such a material, which forms the ball seat and is installed without a protective ring.

This embodiment also features the advantage that the annular disk that forms the ball seat can subsequently be mounted or clipped on as insert in the pressure control handle, which makes possible a significant simplification of the production process.

### BRIEF DESCRIPTION OF THE DRAWINGS

The invention will now be described, by way of example, with reference to the accompanying drawings in which:

FIG. 1 shows a schematic sectional view of a pressure control valve configured as a closed-end pressure regulator according to the prior art;

FIG. 2 shows a schematic sectional view of a part of a pressure control valve according to a first embodiment of the invention configured as a closed-end pressure regulator;

FIG. 3 shows a schematic sectional view of a further embodiment of a pressure control valve configured as a closed-end pressure regulator;

FIG. 4 shows a diagram comprising a comparison between the pressure volume flow characteristic of a pressure control valve according to the prior art and to the present invention;

FIG. 5 shows a schematic sectional view of a further embodiment of a pressure control valve configured as a closed-end pressure regulator according to the invention;

FIG. 6 shows a diagram for the purpose of representing the opening characteristic of the control edges of the valve shown in FIG. 5, and

FIG. 7 shows a diagram for the purpose of representing the pusher position depending on the pressure regulator flow and the pressure regulator force with a valve configured according to the exemplary embodiment of FIG. 5.

### DETAILED DESCRIPTION OF THE INVENTION

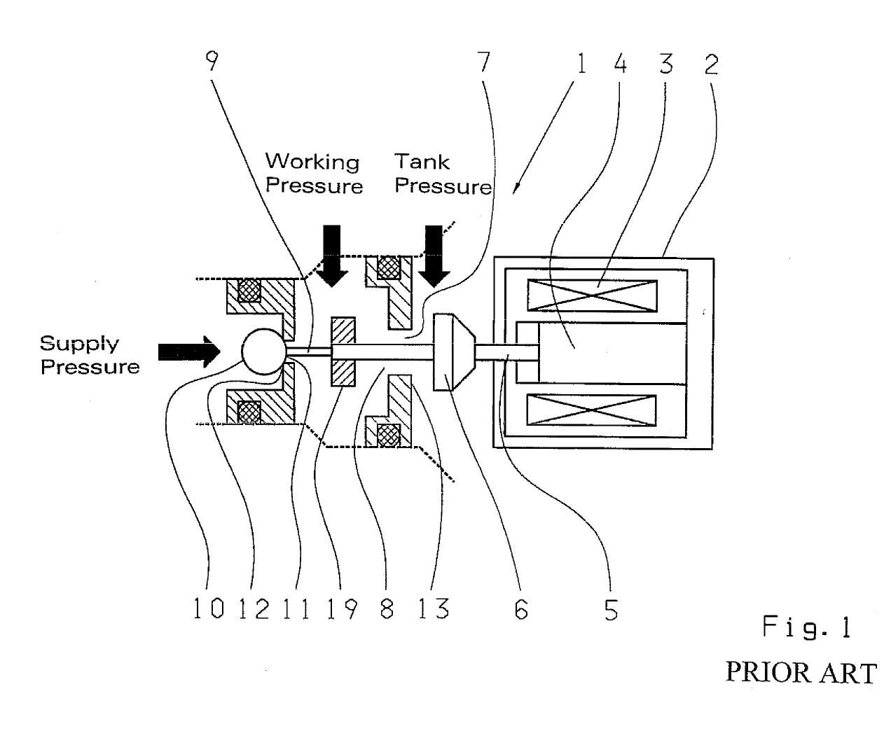

A pressure control valve 1 known from the prior art a closed-end pressure regulator in schematic representation in depressurized position (inlet control edge is closed) in FIG. 1. These proportional pressure control valves 1 are well known to persons skilled in the art so that in what follows only the parts that are necessary to understand the invention will be described.

The pressure control valve 1 that serves as precontrol valve has an electromagnet 2, which customarily has a magnetic core, a magnetic coil 3 and an armature 4 that can be displaced toward the left against the force of a spring, as well as an anchor rod 5, which is displaceable by the armature 4, to bias a closing part 6 against a valve seat 7 to close an opening 8 incorporated in the valve seat 7. A push rod 9 is also provided, which is connected to the anchor rod 5 or can be designed as a single piece with the anchor rod 5, which can move a sealing element 10 designed as a ball out of a second valve seat designed as a ball seat 11. The inlet control edge is identified with reference numeral 12 and the tank edge is identified with reference numeral 13, while a stream diverter is identified with reference numeral 19.

In the valve shown in FIG. 11 the transition from inlet seat to tank seat is abrupt, so that the leakage volume flow of the pressure regulator likewise increases abruptly, without achieving a significant pressure increase. This leads to the disadvantage that a high leakage oil volume flow is produced in the low pressure range of the pressure regulator, while a high volume flow requirement of the transmission is present at the same time in this pressure range, for example, for the purpose of filling the clutch.

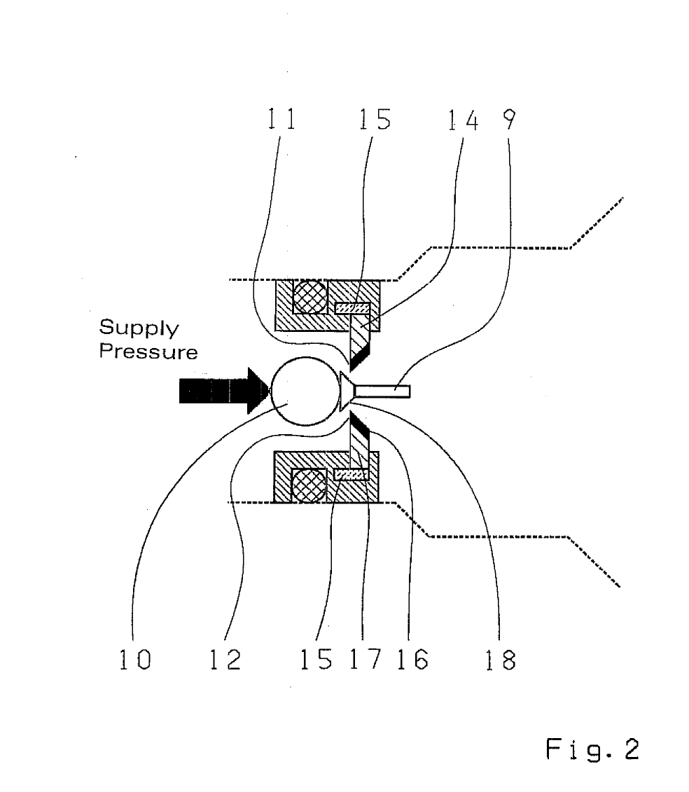

In the example shown in FIG. 2, the push rod 9 is configured in such a way at its end facing the ball seat 11 that the opening cross-section of the inlet control edge 12 can be modified depending on the axial position of the push rod 9 so that the cross-section is reduced when the target pressure is low in order to reduce the inlet volume flow, and the total cross-section of the inlet control edge 12 is available when the target pressure is high in order to satisfy the high volume flow requirements of the follow-up slide valve and to be able to compensate for a high leakage in the working pressure on the other.

As can be seen in FIG. 2, the push rod 9 for this purpose features a geometric expansion 18 at its end facing the ball seat 11 has the shape of a truncated cone that tapers in the direction of the ball seat 11 or the electromagnet 2. In this way the cross-section is reduced when the target pressure is low in order to reduce the inlet volume flow, while the total cross-section of the inlet control edge 12 is available when the target pressure is high in order to satisfy the high volume flow requirements of the follow-up slide valve and to be able to compensate for a high leakage in the working pressure.

In addition, the ball seat 11 is designed in such a way in the shown example that its diameter is smaller on the side facing the sealing element 10 than its diameter on the side facing away from the sealing element 10. That is, the cross-section of the inlet control edge 12 increases in the direction of the magnetic part 2 of the pressure control valve 1 when viewed from the axial direction. The sharpened shape of the ball seat 11 causes the laminar flow to be converted into a turbulent flow, which facilitates the passage of the oil in an advantageous manner at low temperatures.

In the exemplary embodiment shown in FIG. 2, the ball seat 11 is made of a material whose heat expansion coefficient is considerably greater than the heat expansion coefficient of the push rod 9 and which, for this reason, features a disproportionately greater geometric expansion in comparison with the material of the push rod 9 at increasing temperature. With this concept, the cross-section of the inlet control edge 12 features an ever-shrinking cross-sectional surface with increasing temperature.

According to FIG. 2, the ball seat 11 is formed by an annular disk 14, wherein a stable protective ring 15 that is mounted in a fixed manner in a housing, is provided around the outer diameter of the disk by way of which the thermal expansion of the annular disk 14 is guided inward as viewed from the radial direction. The protective ring 15 is preferably made of a material having the same heat expansion coefficient as that of the material of the push rod 9, whereby the cross-section of the inlet control edge 12 can be determined based only on material selection for the annular disk 14 that forms the ball seat 11. An area of the Figure, which is identified with a reference numeral 16, corresponds to the additional expansion of the annular disk 14 toward the inside at high temperature and consequently to the reduction of the cross-section of the inlet control edge 12. The shaded area 17 corresponds to the expansion of the disk 14 at low temperature.

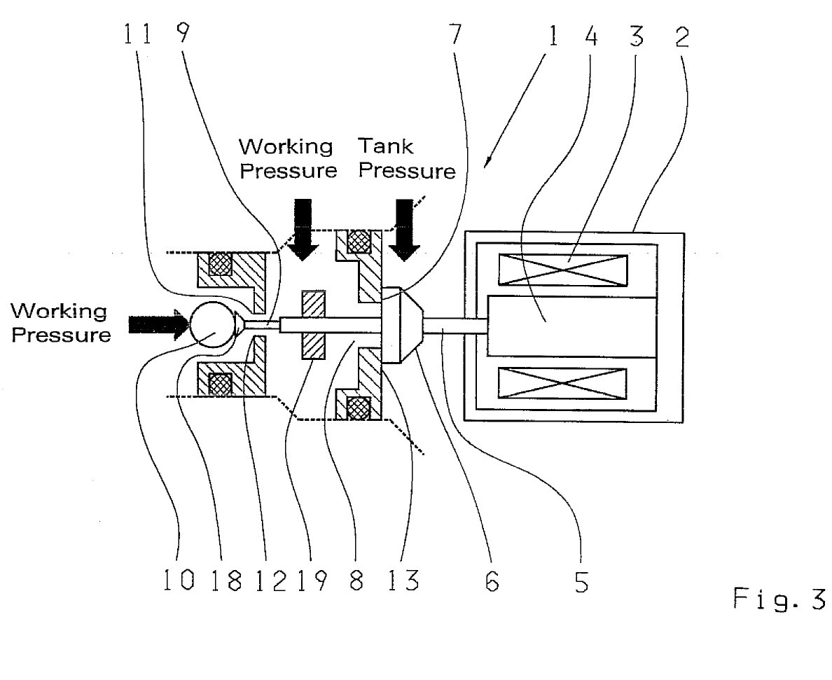

The object of FIG. 3 is an exemplary embodiment of a valve at maximum pressure (tank edge 13 closed, inlet control edge 12 completely open), in which the ball seat 11 is produced according to the prior art, wherein the push rod 9 is designed at its end facing the ball seat 11 according to the embodiment of FIG. 2. Here the full opening cross-section is achieved on the basis of the embodiment of the push rod 9, according to the invention, when the tank edge 13 is completely closed.

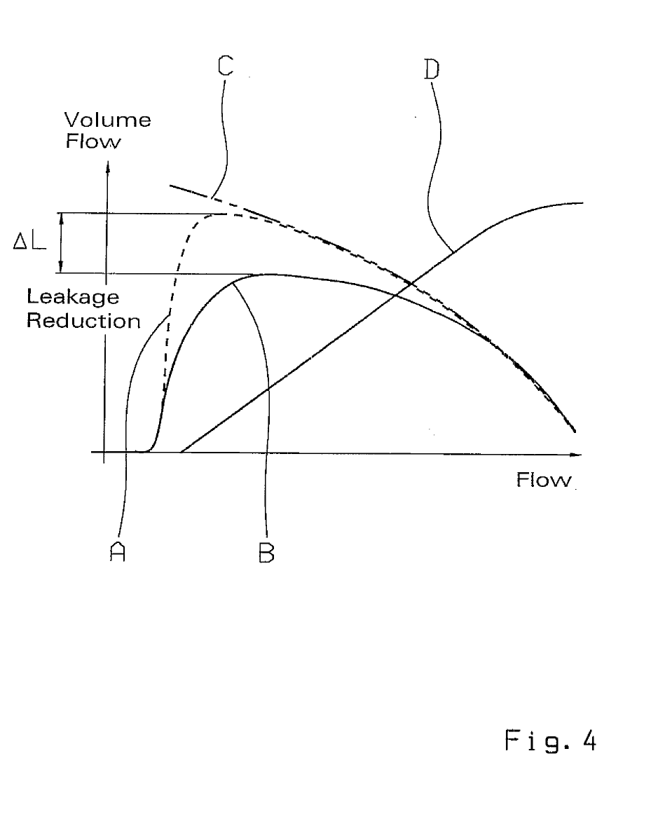

Exemplary pressure/volume flow characteristics of a pressure control valve 1, according to the prior art, and of a pressure control valve 1, designed according to the exemplary embodiment of FIG. 3, are shown in FIG. 4. The curve A here represents the volume flow, depending on the pressure regulator flow, for a valve designed, according to the example of FIG. 1, with constant inlet geometry, while a curve B represents the volume flow, depending on the pressure regulator flow, for a valve designed according to the example of FIG. 3, with variable inlet geometry. A curve C furthermore represents the pressure/volume flow characteristic of a conventional pressure control valve without closed-end function, in which a maximum leakage between the inlet edge and the tank edge occurs, at minimum pressure requirement. The working pressure of the valves, depending on the pressure regulator flow, is represented by a curve D.

As can be seen in FIG. 4, at a minimal pressure requirement, the leakage of a valve with a geometric expansion 18 at the push rod 9 according to the invention is significantly reduced in comparison with a conventional valve configured as a closed-end pressure regulator, whereby the difference amount is indicated with ΔL in the Figure. For comparison, a conventional pressure control valve without closed-end function has maximum leakage.

It can also be seen in FIG. 4 that the transition from the inlet control edge 12 to the tank edge 13 in a valve provided with the geometric expansion 18 at the push rod 9 can in an advantageous manner be made more gentle in comparison with a conventional valve configured as a closed-end pressure regulator.

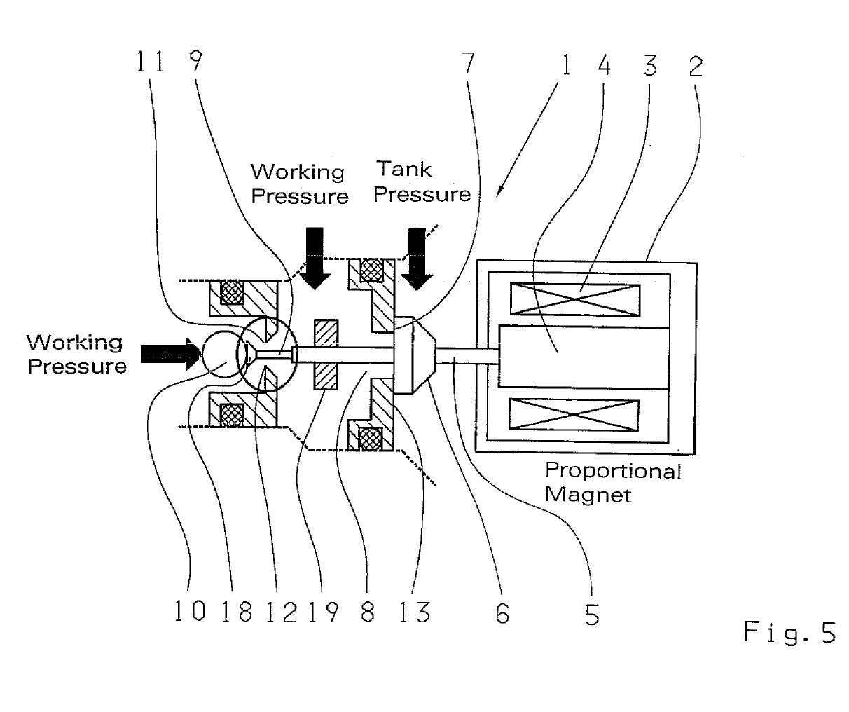

FIG. 5 shows a further exemplary embodiment of a valve in which, in addition to the design of the push rod 9 with a geometric expansion 18, the ball seat 11 is designed in such a way that its diameter on the side facing the sealing element 10 is smaller than its diameter on the side facing away from the sealing element 10. That is, the cross-section of the inlet control edge 12 increases in the direction of the electromagnet part 2 of the valve 1 seen from the axial direction.

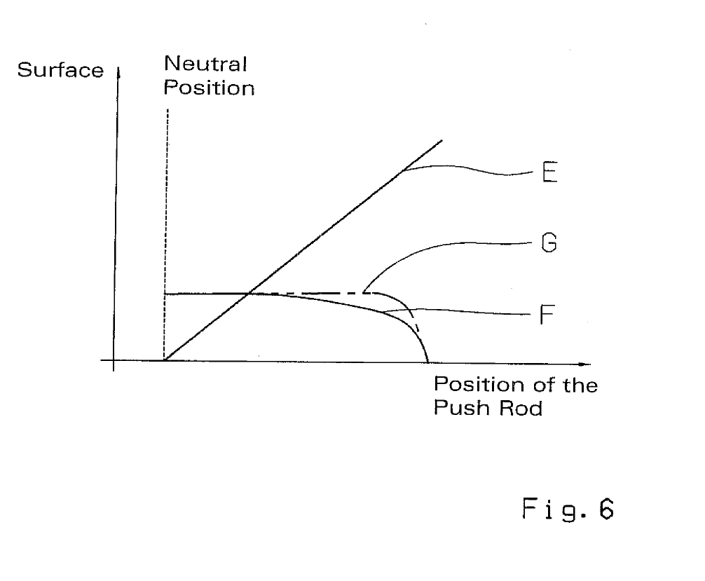

FIG. 6 shows the opening characteristic of the control edges of the valve shown in FIG. 5. Here the tank opening surface is illustrated by a curve E as a function of the position of the push rod 9, while a curve F represents the available cross-sectional surface of the inlet control edge 12 for the valve represented in FIG. 5. For comparison, the available cross-sectional surface of the inlet control edge 12 of a conventional valve configured as a closed-end pressure regulator is shown by a curve G. The tank edge 13 is completely closed in the neutral position and the inlet control edge 12 is completely open.

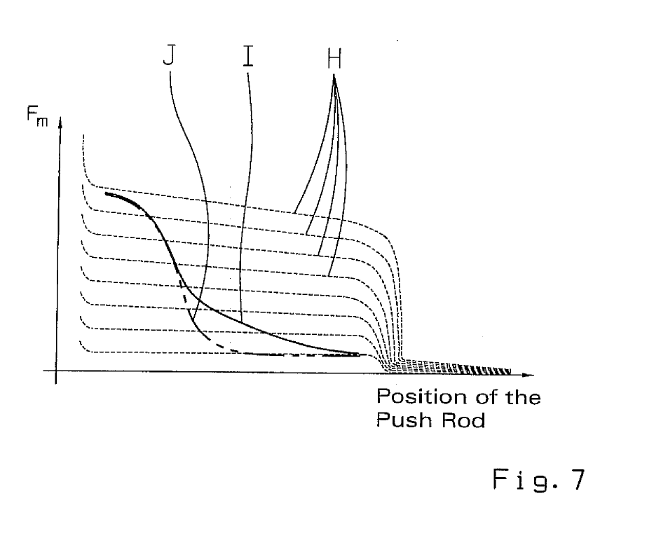

The position of the push rod 9, depending on the pressure regulator flow, and the pressure regulator force Fₘ in a conventional valve, designed as a closed-end pressure regulator, and in a valve, according to FIG. 5, is the object of FIG. 7. The position of the push rod 9 results from the target force, which is proportional to the pressure and the sum of the volume flows (the working pressure is constant when the inlet volume flow is equal to the sum of the tank volume flow and the working volume flow).

Here lines H are lines of force with constant flow. In FIG. 7, a curve I represents the position of the push rod 9 in a valve, according to FIG. 5, while a curve J represents the position of the push rod 9 in a conventional valve designed as a closed-end pressure regulator.

It goes without saying that any constructive design, in particular any spatial arrangement of the components of the pressure control valve, according to the invention, as well as in combination with another, and insofar it is technically practical, falls under the scope of the claims, without influencing the function of the pressure control valve as disclosed in the claims, even if these designs are not explicitly represented in the Figures or in the description.

### REFERENCE NUMERALS

1 pressure control valve
2 electromagnet
3 magnetic coil
4 armature
5 anchor rod
6 closing part
7 valve seat
8 opening
9 push rod
10 sealing element
11 ball seat
12 inlet control edge
13 tank edge
14 annular disk
15 support ring
16 additional expansion of disk 14
17 expansion of disk 14 at low temperature
18 geometric expansion
19 stream diverter
A A volume flow depending on the pressure regulator flow for a valve according to the prior art
B volume flow depending on the pressure regulator flow for a valve configured according to the invention
C pressure/volume flow characteristic of a conventional pressure control valve without CE-function
D working pressure of the valve depending on the pressure regulator flow
E tank opening surface as function of the position of the push rod 9
F available cross-section surface of the inlet control edge as function of the position of the x push rod 9 in a valve according to the invention
Fₘ pressure regulator force
G available cross-section surface of the inlet control edge of a conventional valve designed as a closed-end pressure regulator
H lines of force with constant flow
I position of the push rod in a valve according to the invention
J position of the push rod in a conventional valve designed as a closed-end pressure

1-13. (canceled)

14. A pressure control valve (1) designed as a closed-end pressure regulator, comprising two valve seats (7, 11) arranged in a hydraulic half-bridge circuit, with an electromagnet (2) having a magnetic core, a magnetic coil (3) and an armature (4) with an anchor rod (5) connected thereto, the armature (4) being axially slidable within the electromagnet (2) such that a closing part (6), coupled to the armature (4), being axially slidable to strike a tank edge (13) of a first valve seat (7), a push rod (9), being one of connected to the anchor rod (5) and integrated with the anchor rod (5), biasing a sealing element (10) out of communication with an inlet control edge (12) of a ball seat (11), and at lest one of
an end of the push rod (9) adjacent the ball seat (11) being designed such that an opening cross-section of the inlet control edge (12) of the ball seat (11) being modified depending on an axial position of the push rod (9), the cross-section of the inlet control edge (12) of the ball seat (11) being reduced when a target pressure is low to reduce an inlet volume flow, the opening cross-section of the inlet control edge (12) of the ball seat (11) being maximized when the target pressure is high, and
a diameter of the ball seat (11), on a side facing the sealing element (10), is smaller than a diameter of the ball seat (11) on a side facing away from the sealing element (10).

15. The pressure control valve according to claim 14, wherein the end of the push rod (9) adjacent the ball seat (11) has a geometric expansion (18).

16. The pressure control valve according to claim 15, wherein the geometric expansion (18) has shape of a truncated cone that tapers inwardly toward the ball seat (11).

17. The pressure control valve according to claim 15, wherein the geometric expansion (18) has one of a cylindrical shape, a concave shape, a convex shape and a double cone shape.

18. The pressure control valve according to claim 14, wherein the opening cross-section of the inlet control edge (12) of the ball seat (11) is modified, depending on temperature such that the opening cross-section of the inlet control edge (12), and is maximized at low oil temperatures to enable passage of a large volume flow, and the opening cross-section of the inlet control edge (12) is reduced at high oil temperatures such that a high valve dynamic of a follow-up slide valve is achieved and oil flow leakage is essentially unaffected.

19. The pressure control valve according to claim 18, wherein the ball seat (11) is made of a material having a heat expansion coefficient that is greater than a heat expansion coefficient of a material forming the push rod (9) such that the ball seat (11) has a disproportionately stronger geometric expansion in comparison with the push rod (9) at increasing temperatures.

20. The pressure control valve according to claim 18, wherein the ball seat (11) comprises an annular disk (14) that communicates with a stable supporting ring (15), which is mounted in a fixed manner in a housing, on an outer diameter of the annular disk (14), such that the annular disk (14) thermally expands radially inwardly.

21. The pressure control valve according to claim 20, wherein the supporting ring (15) is made of a material having a heat expansion coefficient essentially equal to a heat expansion coefficient of a material forming the push rod (9).

22. The pressure control valve according to claim 20, wherein the annular disk (14) is made of a material having nonlinear heat expansion behavior above a glass transition point.

23. The pressure control valve according to claim 22, wherein the annular disk (14) is made of polyphenylene sulfide.

24. The pressure control valve according to claim 19, wherein the ball seat (11) is an annular disk (14) manufactured from a material that has a negative heat expansion coefficient.

25. The pressure control valve according to claim 24, wherein the annular disk (14) is a fiberglass-reinforced plastic.

26. The pressure control valve according to claim 25, wherein the annular disk (14) is one of mounted and clipped on as insert in a pressure control handle.
